(19) United States
(12) Patent Application Publication
(10) Pub. No.: US 2004/0071844 A1
(43) Pub. Date: Apr. 15, 2004

(54) Method and apparatus for providing improved appearance and shelf life in packaged meat products

(76) Inventor: Eldon Roth, Dakota Dunes, SD (US)

Correspondence Address: SHAFFER & CULBERTSON, L.L.P., 1114 LOST CREEK BLVD., SUITE 420, AUSTIN, TX, 78746, US

(21) Appl. No.: 10/269,531

(22) Filed: Oct. 11, 2002

(51) Int. Cl. A23C 1/00

(52) U.S. Cl. 426/316

(57) ABSTRACT

A meat processing method includes increasing the pH of a meat product and then applying an oxygen enriching material to the meat product. The pH of the meat product is preferably increased by applying an ammonia-based pH increasing material such as ammonia gas or ammonium hydroxide solution. The oxygen enriching material may comprise an atmosphere made up of a substantial fraction of oxygen gas. The pH increased and oxygen treated meat product may be packaged either in a chub-type package or a tray-type package for shipping to a retail outlet.

### TECHNICAL FIELD OF THE INVENTION

This invention relates to meat processing. More particularly, the invention relates to processes and systems for improving the appearance and shelf life of packaged meats, especially comminuted beef.

### BACKGROUND OF THE INVENTION

Meats were traditionally distributed to consumers through relatively small retail butcher shops. The meat was shipped to the butcher shop in the form of a whole or substantially whole carcass and employees at the butcher shop then cut the carcass down into various products for sale to the consumer. Steaks, roasts, filets, and finely comminuted products such as ground beef were all distributed to consumers in this fashion. The final products were commonly placed in a show case at the butcher shop from which the consumer could select the desired product. A butcher shop employee retrieved the selected product from the case and wrapped the product in a suitable wrapping material at the time of purchase.

Although this traditional distribution model persists, a relatively low percentage of meat is distributed in this fashion today. Most meat is now distributed under a distribution model relying on more centralized processing. Under this centralized processing distribution model, the whole carcass is cut down to the individual products at a centralized processing facility. The individual products are then packaged in the final retail packaging and distributed to retail outlets for sale to the consumer.

Although this newer distribution model is much more efficient in terms of labor costs, it has raised some difficult issues for the meat industry. Perhaps the most difficult issue is that of shelf life for the final packaged product produced at the centralized processing facility. In order for the centralized processing model to be successful, the product must have sufficient shelf life to allow the product to be shipped to the retail outlets and then remain in a desirable condition for a reasonable period of time at the retail outlets. The centralized processing distribution model requires that the final packaged product remain wholesome and retain a desirable appearance for a relatively long time to accommodate the time the product must be in transit to the retail outlet and to accommodate the time that the product is likely to remain in the retail outlet display case available to the consumer.

If properly refrigerated and protected from contamination, many final meat products may remain wholesome for a fairly long period of time. The retail shelf life of a packaged meat product is determined more by the physical appearance of the meat product. Generally, consumers equate a bright red color with the freshness of the product, especially for ground meat products. However, depending upon how the product is packaged, red meat can lose the desirable red color relatively quickly after being placed in the packaging material. Thus, packaging a meat product can have the effect of reducing the shelf life of the meat product.

A common packaging arrangement used for finely comminuted meat products such as ground beef produced at a centralized processing facility is known as a chub package. A chub package is a generally cylindrical package of thin plastic material sealed at both ends to form a container for a quantity of finely comminuted meat. Chub packaging uses relatively inexpensive materials and equipment, and allows large amounts of product to the packed into a small area for shipping. The problem with chub packaging for ground beef is that the beef takes on a dark purple-brown color very quickly after packaging. While the product may return to a bright red appearance quickly after removal from the chub package, consumers may take the dark purple-brown color as an indication that the product is not fresh, is unwholesome, or is otherwise undesirable. Thus, chub packaged ground beef generally must be sold at a lower retail price than butcher shop ground beef or ground beef packaged in other fashions, and the chub packages must be opaque to prevent the consumer from seeing the meat product at the time of purchase.

Another packaging arrangement commonly used for meat products may be referred to as tray-type packaging. In tray-type packaging, the final processed meat product is placed in a tray of suitable material, such as expanded polystyrene, and then sealed on the tray with an overwrap material comprising a thin transparent plastic film. Although these traditional overwrap tray-type packages allowed the consumer to see the product at the time of purchase or selection, the meat product maintained an appealing appearance for only a relatively short time in these types of packages and thus the product had a relatively short shelf life. Due to the relatively short shelf life, traditional overwrap tray-type packaging cannot be used for meat products packaged at a centralized processing facility. Rather, the meat products using this type of packaging must generally be processed to final form and packaged at the retail outlet.

More recent packaging systems attempt to control the atmosphere within the package to maintain a desirable color in the product. In these controlled-atmosphere packaging systems, the meat product is generally placed in a deep tray of suitable material and the top of the tray above the level of the meat product is sealed with a suitable film leaving a relatively large amount of open space around the meat product. A desired atmosphere is placed in this open space to produce the desired effect on the color of the meat product. One type of controlled-atmosphere packaging system maintains a high oxygen content in the package in order to maintain a more desirable color in the meat product for a longer period of time. Another type of controlled-atmosphere packaging initially maintains an atmosphere having a low oxygen content in the package. The film used to seal the tray in this low-oxygen packaging system includes two layers, an outer layer which is impermeable to oxygen and an inner layer which is permeable to oxygen. The outer film layer maintains the desired low-oxygen atmosphere in the package while the package is in transit to the retail outlet. However, once the package reaches the retail outlet, the oxygen impermeable layer may be peeled off to allow oxygen from the atmosphere to reach the meat product in the package. This addition of oxygen is known to produce an oxygen “bloom” in the meat product resulting the bright red color which consumers equate with freshness.

Low-oxygen atmosphere packaging suffers from increased labor costs at the retail facility and greatly increased packaging costs. High-oxygen atmosphere packaging is also relatively more expensive than traditional tray-type packaging and chub packaging. Also, high-oxygen atmosphere packaging may promote oxidation rancidity in the packaged meat product. That is, the high oxygen content in the package atmosphere promotes oxidation of fats in the packaged meat product. This oxidation produces an off flavor in the meat product and reduces the shelf life of the product when compared to either low-oxygen or chub-style packaging. Both low-oxygen and high-oxygen controlled-atmosphere packaging systems suffer from the fact that packaging space is taken up by the desired atmosphere. Thus, relatively less product can be stored in a given space as compared to traditional chub and tray-type packaged products and significantly higher transportation costs are incurred in distributing the product to retail establishments.

### SUMMARY OF THE INVENTION

The present invention provides methods and packaging systems for improving the appearance and shelf life of packaged meat products, especially red meat products such as beef. One preferred method according to the present invention includes increasing the pH of a meat product, preferably by applying an ammonia-based pH increasing material such as ammonia gas or ammonium hydroxide solution. The method also includes the step of applying an oxygen enriching material to the meat product either before or preferably after increasing the pH of the meat product. The pH increased and oxygen treated meat product may be packaged either in a chub-type package or a tray-type package for shipping to the retail outlet. Increasing the pH of the meat product according to the invention inhibits oxidation rancidity in the meat product while the increased oxygen content helps the meat retain the desirable bright red color. The preferred ammonia-based pH increasing material also helps maintain the desired red color. This bright red color is maintained both in the traditional chub package and in the traditional tray-type package with no special atmosphere within the package.

An oxygen enriching material according to the invention comprises any material that adds oxygen to the meat product more effectively than air at regular atmospheric conditions. For example, pressurized air injected into the meat product comprises an oxygen enriching material within the scope of the invention and following claims. However, an oxygen enriching material preferably includes an oxygen content greater than air, and more preferably no less than approximately 50 percent oxygen. Liquid oxygen enriching materials such as hydrogen peroxide may also be used within the scope of the invention.

The pH modification required in the present invention preferably places the meat at a pH value no less than approximately 7.0. In some forms of the invention, the pH of the meat product may be increased to a relatively high level above 7.0, and then reduced with a suitable pH reducing material back down to the desired final pH for packaging. The preferred step for increasing the pH of the meat product comprises applying an ammonia-based pH increasing material. As used in this disclosure and the accompanying claims, an ammonia-based pH increasing material comprises any material that produces ammonium hydroxide in moisture within the meat product. Examples of ammonia-based pH increasing material include ammonia gas and ammonium hydroxide solution (aqueous ammonia). In the case of ammonia gas, the gas goes into solution in the moisture associated with the meat product to produce the desired ammonium hydroxide solution. In the case of an ammonium hydroxide solution, the solution simply combines with moisture in the meat product to produce the desired ammonium hydroxide solution in the moisture. It will be appreciated, however, that the invention is not limited to pH increasing steps that rely on the application of a pH increasing material. Rather, the pH of meat may be increased in other fashions within the scope of the invention, such as by defatting.

In one form of the invention, the treated meat product may be packaged in a tray-type package. Where tray-type packaging is used, any atmosphere within the package is preferably limited to a non-absorbing atmosphere. This non-absorbing atmosphere is made up of materials such as nitrogen gas and inert gases that are not absorbed into the treated meat product.

A preferred packaging system according to the invention includes a pH increasing arrangement for increasing the pH of the meat product, and an oxygen application arrangement for applying the oxygen enriching material. The packaging system further includes a packaging device for receiving the pH increased/oxygen treated meat product and for sealing a quantity of the treated meat product in a packaging material. In the preferred form of the invention, the pH increasing arrangement comprises a sparging device that sparges the pH increasing material into the meat product so as to distribute the pH increasing material substantially throughout the meat product to produce a desired pH increase. The preferred oxygen application arrangement also includes a sparging device that is adapted to sparge the desired oxygen enriching material into the meat product so as to distribute the oxygen enriching material throughout the meat product.

The treatment methods and systems according to the present invention improve the color of red meat products such as beef products. Most importantly, the invention allows meat products, especially unfrozen meat products, to be packaged in traditional chub packaging without the damage to product color normally associated with chub packaging. The invention may also be used to improve the appearance and shelf life of traditional tray-type packaged red meats.

The present invention is useful for treating many different types of meat products, especially red meat products such as beef and lamb/mutton. Although the invention is particularly well suited for improving the appearance and shelf life of finely comminuted meat such as ground beef, larger cuts of comminuted meat may also be treated according to the invention. “Whole muscle” cuts of meat such as roasts, steaks, and filets may be treated in accordance with the present invention. The invention may also be used to improve the appearance and shelf life of restructured meat products. It will also be appreciated that the meat product being treated according to the invention as set out in the following claims may include non meat products such as spices, fillers, and extenders.

These and other advantages and features of the invention will be apparent from the following description of the preferred embodiments, considered along with the accompanying drawings.

### BRIEF DESCRIPTION OF THE DRAWINGS

FIG. 1 is a diagrammatic representation of a meat product treatment system embodying the principles of the invention.

FIG. 2 is a section view of a device suitable for applying a pH increasing material, pH decreasing material, or oxygen enriching material according to the present invention.

FIG. 3 is a section view of a multistage sparging device suitable for applying two different treatment materials to a finely comminuted meat product according to the present invention.

### DESCRIPTION OF PREFERRED EMBODIMENTS

The high-level diagrammatic representation of FIG. 1 shows that a treatment system 10 embodying the principles of the invention includes generally three primary components. One component comprises a pH increasing arrangement 11 for increasing the pH of a meat product. Another primary component comprises an oxygen application arrangement 12 for applying an oxygen enriching material to the meat product. The third primary component comprises a packaging device 14. Packaging device 14 is connected to receive the meat product after the product has been treated through pH increasing arrangement 11 and oxygen application arrangement 12, and seals a quantity of the meat product in a suitable packaging material.

pH increasing arrangement 11 may include any suitable arrangement for increasing the pH of the meat product. Some forms of the invention may increase the pH of the meat product by removing fat from the meat product. Other pH increasing arrangements may include a device for applying a pH increasing material to the meat product. Both of these methods may be employed together to increase the pH of the meat product in some forms of the present invention. Also, the pH increasing arrangement may increase the pH of a meat product according to the invention by mixing a pH increased meat product with a non pH increased meat product where the final mixed product has a pH greater than the pH that would otherwise exist in the mixed product.

Where pH increasing arrangement 11 comprises a device or arrangement for applying a pH increasing material, the arrangement preferably includes a sparging device that operates to sparge the pH increasing material into the meat product. One suitable sparging device is disclosed in U.S. Pat. No. 6,142,067 entitled “Apparatus for Treating Ammoniated Meats,” the entire content of which is incorporated herein by this reference. Another suitable sparging device is shown in U.S. patent application Ser. No. 10/173,955 entitled “Method and Apparatus for Exposing Comminuted Foodstuff to a Processing Fluid.” The entire content of this application is also incorporated herein by this reference.

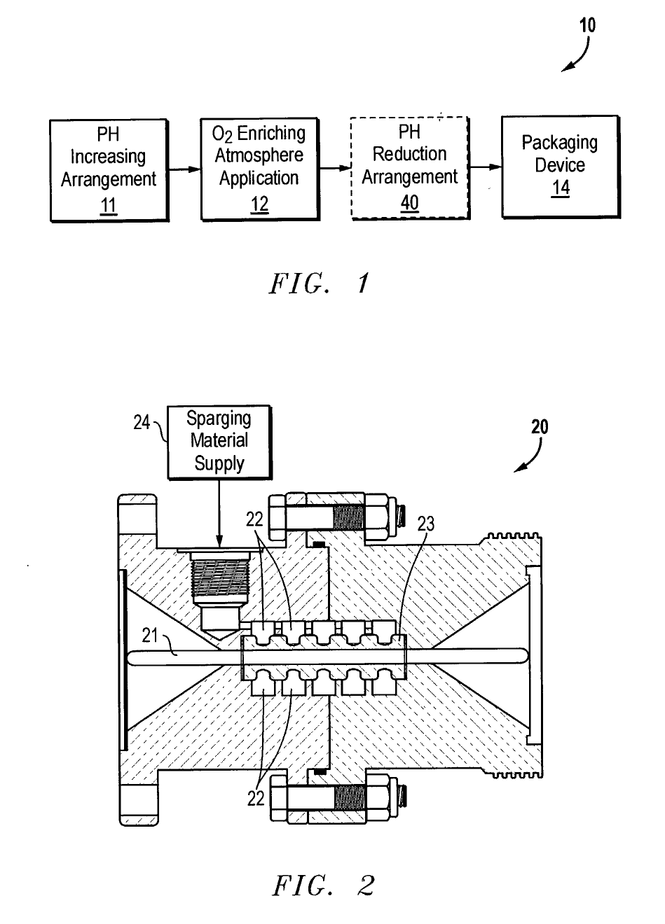

FIG. 2 shows a section view of a sparging device 20 which is the subject of U.S. patent application Ser. No. 10/173,955. Sparging device 20 includes a passage 21 through which the meat product to be treated is directed. A fluid chamber 22 is positioned adjacent to the meat product passage 21, and a fluid communication arrangement 23 provides fluid communication between the fluid chamber and the meat product passage. In operation, the meat product to be treated is pumped or otherwise directed through passage 21 and the pressure in fluid chamber 22 is maintained at a pressure sufficient to force the fluid from chamber 22 into the meat product passage and into contact with the meat product therein. It will be appreciated that a source of the material to be sparged into the meat product is connected to supply the material to fluid chamber 22 under the desired operating pressure to force the material into meat product passage 21. This sparging material supply arrangement is shown schematically at reference numeral 24 in FIG. 2.

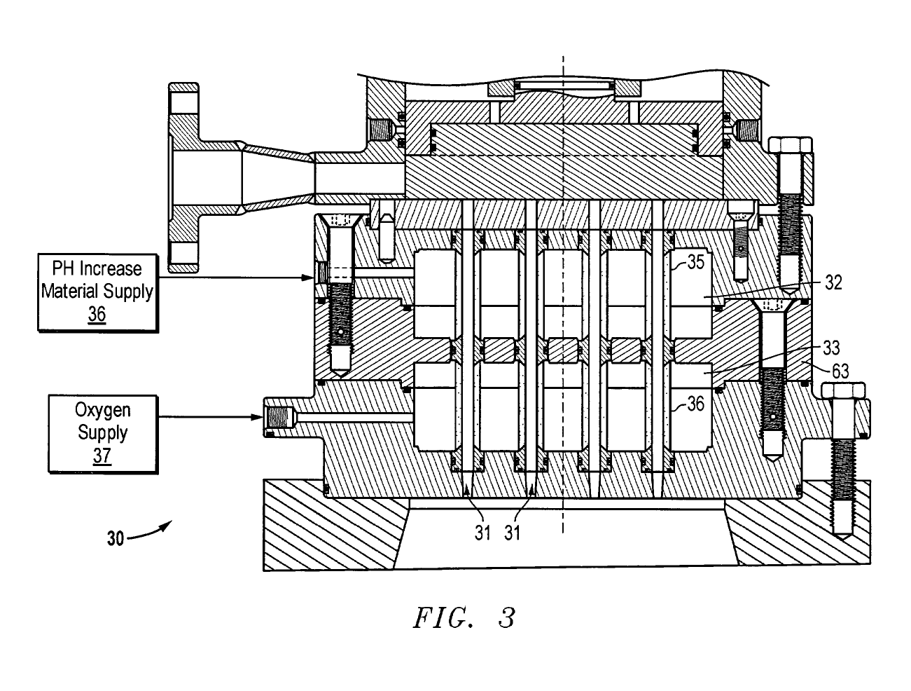

Oxygen application arrangement 12 also preferably comprises a sparging device such as the sparging device shown in U.S. Pat. No. 6,142,067, or the device 20 shown in FIG. 2 (from U.S. patent application Ser. No. 10/173,955). However, for the oxygen application, the material supplied to fluid chamber 23 in FIG. 2 comprises an oxygen enriching material such as compressed air or an atmosphere having a greater oxygen content than air, for example. Sparging material supply arrangement 24 will comprise an arrangement for supplying the desired oxygen enriching material.

Where the pH increasing arrangement applies a pH increasing material, a multistage sparger may be used to apply the pH increasing material and oxygen enriching material in the same device. U.S. patent application Ser. No. 10/______ entitled “Sparging Device and Method for Adding a Processing Fluid to a Foodstuff,” filed concurrently herewith, discloses a multistage sparger suitable for use in the present invention. The entire content of this application is incorporated herein by this reference. FIG. 3 in the present disclosure shows a section view of the multistage sparger 30 disclosed in U.S. patent application Ser. No. 10/______. This multistage sparger 30 includes one or more meat product passages 31, a first fluid chamber 32, and a second fluid chamber 33. Both fluid chambers 32 and 33 are in fluid communication with the passages 31 through a respective fluid communication arrangement 34 and 35.

When used according to the present invention, first fluid chamber 32, may, for example, be connected to a pH increasing material supply 36. Second fluid chamber 33 may be connected to an oxygen enriching material supply 37. As the meat product to be treated is pumped or otherwise directed through passages 31, the pH increasing material is applied though first fluid communication arrangement 34 while the oxygen enriching material is applied through second fluid communication arrangement 35. This multiple stage arrangement may be used in lieu of two separate individual sparging devices such as the device 20 shown in FIG. 2.

FIG. 1 indicates that the meat product is first processed through pH increasing arrangement 11 and then processed through oxygen application arrangement 12 prior to being delivered to packaging arrangement 14. However, the invention is not limited to this processing sequence. Rather, oxygen application arrangement 12 may be positioned ahead of pH increasing arrangement 11 in the process stream.

FIG. 1 also indicates that packaging system 10 may include a second pH adjusting arrangement 40. This second pH adjusting arrangement 40 may operate to decrease the pH of the meat product. For example, one preferred form of the invention may include a separate sparging device, or sparging stage in a multistage device, for sparging carbon dioxide gas or some other pH reducing material into the meat product. Although this second pH adjusting arrangement 40 is shown positioned between oxygen application arrangement 12 and packaging device 14, the second pH adjusting arrangement may be positioned elsewhere in the process stream, but preferably after the pH increasing arrangement.

Packaging device 14 shown in FIG. 1 may comprise any of a number of different packaging devices suitable for packaging meat products. In one preferred form of the invention, packaging device 14 comprises a chub packaging device. An example of a suitable chub packaging device comprises the KARTRIDGPAK™ CHUBMAKER™ packaging device by Packaging Technologies of Davenport Iowa. In other forms of the invention, packaging device 14 may comprise either a standard tray-type packaging device or a controlled-atmosphere packaging device. This controlled-atmosphere packaging device may be used to form a suitable non-absorbing or maintenance material atmosphere within the meat product package.

A treatment method according to the invention may be described with reference to FIG. 1. The method includes increasing the pH of a meat product and applying an enriching oxygen material to the meat product either before or after increasing the pH of the meat product. The step of increasing the pH of the meat product preferably includes applying an ammonia-based pH increasing material to increase the pH of the meat product to a pH value no less than approximately 7.0. The step of applying the enriching oxygen material preferably comprises applying an atmosphere containing no less than approximately 50 percent oxygen. Both the pH increasing material application and the enriching oxygen material application preferably include distributing the respective material throughout the meat product. The sparging devices described above may be used to provide this desired distribution of treatment material throughout the meat product.

Once the pH of the meat product has been increased and the desired enriching oxygen material has been applied, the invention preferably includes sealing the meat product in a package such as a chub package or a tray-type package. The method may also include sealing gasses within the package together with the meat product. Where gasses are sealed in the package, the gasses preferably comprise non-absorbing materials such as nitrogen gas and inert gasses.

The invention is not limited to any particular packaging materials. Since the oxygen that helps maintain the desired color in the product is added to the product before packaging, there is generally no requirement that the packaging material be either permeable or impermeable to oxygen. The packaging material according to the invention simply provides a protective barrier for the meat product to prevent contamination or any significant absorption of materials from the atmosphere external to the package. Unlike prior controlled-atmosphere packaging systems, the packaging material used to package meat products according to the present invention is not required to maintain any particular atmosphere within the package.

It will be appreciated that the sparging devices described above for applying the pH increasing material as well as the enriching oxygen material to the meat product are best suited for treating finely comminuted meat products. However, the invention is not limited to processing or packaging finely comminuted meat products. Rather, the invention has application to improve appearance and shelf life in larger, “whole muscle” comminuted meat products such as steaks, roasts, filets, and other types of meat in addition to finely comminuted meat such as ground beef. Any suitable technique may be used to apply the pH increasing material and oxygen enriching material to these whole muscle meat products. Unlike the preferred treatment for finely comminuted meat products, pH increasing material and oxygen enriching material may not be distributed throughout the volume of the whole muscle meat products. Rather, the pH and oxygen treatments for whole muscle meat products may be controlled to produce the desired pH change and oxygen enrichment only in a surface layer of the meat product.

It will be appreciated that the meat treated according to the present invention may be subjected to additional treatments or additives. These additional treatments may be combined with the steps of the present invention or may be performed entirely separately. For example, meat treated according to the present invention may also be treated with an antioxidant such as a rosemary derivative or any other suitable antioxidant. The antioxidant may be mixed into the meat or may be sparged into the meat using a suitable sparging device either before, during, or after the treatment according to the present invention.

The above described preferred embodiments are intended to illustrate the principles of the invention, but not to limit the scope of the invention. Various other embodiments and modifications to these preferred embodiments may be made by those skilled in the art without departing from the scope of the following claims.

1. A method for improving appearance and shelf life in a meat product, the method including the steps of:
(a) increasing the pH of a meat product; and
(b) applying an oxygen enriching material to the surface of the meat product before or after increasing the pH of the meat product.

2. The method of claim 1 wherein the step of increasing the pH of the meat product comprises increasing the pH of the meat product to a pH value of no less than approximately 7.0.

3. The method of claim 1 wherein the oxygen enriching material is made up of no less than approximately 50% oxygen gas.

4. The method of claim 1 further including the steps of:
(a) sealing the meat product in a package after increasing the pH of the meat product and after applying the oxygen enriching material; and
(b) sealing a maintenance atmosphere within the package with the meat product, the maintenance atmosphere including a non-absorbing material.

5. The method of claim 1 wherein the meat product comprises a finely comminuted meat product and the step of increasing the pH of the meat product includes distributing a pH increasing material throughout the finely comminuted meat product.

6. The method of claim 5 wherein the step of applying the oxygen enriching material to the surface of the meat product includes distributing the oxygen enriching material throughout the finely comminuted meat product.

7. A method for improving appearance and shelf life in a finely comminuted packaged meat, the method including the steps of:
(a) distributing a pH increasing material throughout the finely comminuted meat product;
(b) distributing an oxygen enriching material throughout the finely comminuted meat product either before or after distributing the pH increasing material throughout the finely comminuted meat; and
(c) sealing a quantity of the meat product in a packaging material after distributing the pH increasing material and oxygen enriching material throughout the finely comminuted meat.

8. The method of claim 7 wherein the meat product fills substantially an entire package volume defined by the sealed packaging material.

9. The method of claim 7 wherein step of sealing the quantity of meat product in the packaging material includes supporting the treated meat product on a tray and placing a sealing film over a top of the tray.

10. The method of claim 9 including the step of forming a non-absorbing material atmosphere in a space between the product on the tray and the sealing film over the top of the tray.

11. The method of claim 7 wherein the pH increasing material comprises an ammonia-based material.

12. The method of claim 11 wherein the oxygen enriching material comprises a gas made up of no less than 50% oxygen.

13. The method of claim 7 wherein the oxygen enriching material comprises a gas made up of no less than 50% oxygen.

14. A method for improving appearance and shelf life in a meat product, the method including the steps of:
(a) increasing the pH of a meat product by contact with a pH increasing material including gaseous ammonia or ammonium hydroxide solution; and
(b) applying an oxygen enriching material to the meat product.

15. The method of claim 14 wherein the oxygen enriching material includes no less than 50% oxygen.

16. The method of claim 14 further including the step of sealing the meat product in a packaging material after increasing the pH of the meat product and after applying the oxygen enriching material to the meat product.

17. The method of claim 14 wherein the step of sealing the meat product in the packaging material includes sealing the treated meat produce in the packaging material together with a non-absorbing atmosphere.

18. The method of claim 17 wherein the non-absorbing atmosphere is made up predominantly of one or more inert gasses.

19. The method of claim 14 further including the step of reducing the pH of the meat product.

20. The method of claim 19 further including the step of maintaining the pH of the meat product at a pH value of no less than approximately 7.0 after applying the oxygen enriching material to the meat product.

21. A meat packaging system including:
(a) a pH increasing arrangement for increasing the pH of a meat product;
(b) an oxygen application arrangement for applying an oxygen enriching material to the meat product; and
(c) a packaging device connected to receive the meat product after the pH of the meat product has been increased and after the application of the oxygen enriching material, the packaging device for sealing a quantity of the meat product in a packaging material.

22. The meat packaging system of claim 21 wherein the pH increasing arrangement comprises a pH increasing material sparging device and wherein the pH increasing material includes ammonia gas or ammonium hydroxide solution.

23. The meat packaging system of claim 22 wherein the oxygen application arrangement comprises an oxygen sparging device and wherein the oxygen enriching material is made up of no less than 50% oxygen.

24. The meat packaging system of claim 21 wherein the oxygen application arrangement comprises an oxygen sparging device and wherein the oxygen enriching material is made up of no less than 50% oxygen.

25. The meat packaging system of claim 21 wherein the packaging device comprises a chub forming device.

26. The meat packaging system of claim 21 wherein the packaging device comprises a tray-type packaging device or a controlled-atmosphere tray-type packaging device.
